(19) United States
(12) Patent Application Publication
(10) Pub. No.: US 2024/0144825 A1
(43) Pub. Date: May 2, 2024

(54) PARKING LOT MANAGEMENT METHOD AND PARKING LOT MANAGEMENT SYSTEM

(71) Applicant: TOYOTA JIDOSHA KABUSHIKI KAISHA, Toyota-shi Aichi-ken (JP)

(72) Inventor: Hiroya CHIBA, Fuji-shi Shizuoka-ken (JP)

(73) Assignee: TOYOTA JIDOSHA KABUSHIKI KAISHA, Toyota-shi Aichi-ken (JP)

(21) Appl. No.: 18/371,492

(22) Filed: Sep. 22, 2023

(30) Foreign Application Priority Data
Oct. 27, 2022 (JP) 2022-172422

(51) Int. Cl. G08G 1/14

(52) U.S. Cl. CPC G08G 1/146

(57) ABSTRACT

A parking lot includes a plurality of parking spaces monitored by a single camera. A parking lot management method includes a parking space allocation process that allocates an available parking space among the plurality of parking spaces to an entry vehicle entering the parking lot. The plurality of parking spaces include a priority parking space depending on a size of the entry vehicle. Even when the entry vehicle is parked in the priority parking space, a predetermined percentage or more of a parking space adjacent to the priority parking space is not hidden by the entry vehicle when viewed from the single camera. The parking space allocation process includes: acquiring information on the size of the entry vehicle; recognizing the priority parking space among the plurality of parking spaces based on the size of the entry vehicle; and preferentially allocating the priority parking space to the entry vehicle.

### CROSS-REFERENCES TO RELATED APPLICATION

The present disclosure claims priority to Japanese Patent Application No. 2022-172422, filed on Oct. 27, 2022, the contents of which application are incorporated herein by reference in their entirety.

### TECHNICAL FIELD

The present disclosure relates to a technique for managing a parking lot. In particular, the present disclosure relates to a technique for managing a parking lot including a plurality of parking spaces monitored by a single camera.

### BACKGROUND ART

Patent Literature 1 discloses a status detection device that detects a status (full or available) of a parking lot. The status detection device includes a monitor camera that takes a picture of the parking lot from above. The status detection device detects the status of the parking lot based on an image of the parking lot acquired by the monitor camera. More specifically, the status detection device detects whether or not a vehicle is present at each parking position by comparing the latest image with an image in a non-parking state.

### LIST OF RELATED ART

Patent Literature 1: Japanese Laid-Open Patent Application No. JP-2001-SUMMARY

A case where a parking space in a parking lot is monitored by using a camera is considered. For example, a usage status (available or in use) of a parking space is determined based on an image of the parking space captured by the camera.

There may be a need to monitor a plurality of parking spaces with a single camera in order to reduce costs. However, when a plurality of parking spaces are monitored by using a single camera, a part of a certain parking space is likely to be hidden by a parked vehicle parked in an adjacent parking space. In other words, influence of occlusion on visibility of the parking space increases. Depending on a size of the parked vehicle and a positional relationship between the parking space and the single camera, the visibility of the parking space may be significantly decreased. Decrease in the visibility of the parking space causes decrease in accuracy of monitoring the parking space. For example, when a marker provided in an available parking space cannot be seen from the single camera due to the occlusion, it may be erroneously determined that a vehicle is parked in the available parking space.

An object of the present disclosure is to provide a technique capable of suppressing decrease in accuracy of monitoring when a plurality of parking spaces in a parking lot are monitored by a single camera.

A first aspect is directed to a parking lot management method for managing a parking lot including a plurality of parking spaces monitored by a single camera.

The parking lot management method includes a parking space allocation process that allocates an available parking space among the plurality of parking spaces to an entry vehicle entering the parking lot.

The plurality of parking spaces include a priority parking space depending on a size of the entry vehicle.

Even when the entry vehicle is parked in the priority parking space, a predetermined percentage or more of a parking space adjacent to the priority parking space is not hidden by the entry vehicle when viewed from the single camera.

The parking space allocation process includes:
acquiring information on the size of the entry vehicle;
recognizing the priority parking space among the plurality of parking spaces based on the size of the entry vehicle; and
preferentially allocating the priority parking space to the entry vehicle.

A second aspect is directed to a parking lot management system for managing a parking lot including a plurality of parking spaces monitored by a single camera.

The parking lot management system includes one or more processors.

The one or more processors are configured to execute a parking space allocation process that allocates an available parking space among the plurality of parking spaces to an entry vehicle entering the parking lot.

The plurality of parking spaces include a priority parking space depending on a size of the entry vehicle.

Even when the entry vehicle is parked in the priority parking space, a predetermined percentage or more of a parking space adjacent to the priority parking space is not hidden by the entry vehicle when viewed from the single camera.

The parking space allocation process includes:
acquiring information on the size of the entry vehicle;
recognizing the priority parking space among the plurality of parking spaces based on the size of the entry vehicle; and preferentially allocating the priority parking space to the entry vehicle.

According to the present disclosure, in the parking space allocation process, the priority parking space is preferentially allocated to the entry vehicle. When the entry vehicle is parked in the priority parking space, the influence of occlusion caused by the entry vehicle is suppressed to less than a certain level. It is thus possible to suppress the decrease in accuracy of monitoring even in the situation where the plurality of parking spaces are monitored by the single camera.

### BRIEF DESCRIPTION OF DRAWINGS

FIG. 1 is a conceptual diagram for explaining an overview of a parking lot and a parking lot management system according to an embodiment;

FIG. 2 is a conceptual diagram for explaining an example of a method for determining a usage status (available or in use) of a parking space;

FIG. 3 is a conceptual diagram showing an example of a case where a plurality of parking spaces are monitored by a single camera;

FIG. 4 is a conceptual diagram for explaining an issue;

FIG. 5 is a conceptual diagram for explaining an example of a priority parking space for a first vehicle according to an embodiment;

FIG. 6 is a conceptual diagram for explaining an example of a priority parking space for a second vehicle according to an embodiment;

FIG. 7 is a conceptual diagram showing an example of a priority parking space for a first vehicle and a priority parking space for a second vehicle according to an embodiment;

FIG. 8 is a conceptual diagram showing an example of setting of priorities of parking spaces in a parking space allocation process according to an embodiment;

FIG. 9 is a block diagram showing a configuration example of a parking lot management system according to an embodiment; and

FIG. 10 is a flowchart showing a parking space allocation process performed by a parking lot management system according to an embodiment.

### DETAILED DESCRIPTION

Embodiments of the present disclosure will be described with reference to the accompanying drawings.

### 1. Overview of Parking Lot and Parking Lot Management System

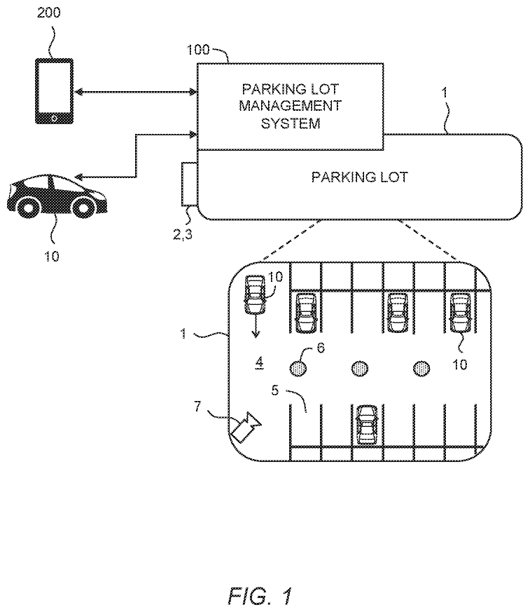

FIG. 1 is a conceptual diagram for explaining an overview of a parking lot 1 and a parking lot management system 100 according to the present embodiment.

The parking lot 1 includes an entry area 2, an exit area 3, a passage 4, and parking spaces 5. The entry area 2 is an area in which a vehicle 10 entering the parking lot 1 (i.e., an entry vehicle) stops. The exit area 3 is an area in which a vehicle 10 leaving the parking lot 1 (i.e., an exit vehicle) stops. The passage 4 is an area where the vehicle 10 travels. The parking space 5 is a space in which a vehicle 10 is parked. For example, the parking space 5 is partitioned by a partition line.

The parking lot management system 100 manages the parking lot 1. For example, the parking lot management system 100 monitors the parking lot 1 by using a camera 7 installed in the parking lot 1. As another example, the parking lot management system 100 may use the camera 7 to grasp a usage status (available or in use) of each parking space 5. As still another example, the parking lot management system 100 may allocate an available parking space 5 to a vehicle 10 (an entry vehicle) entering the parking lot 1.

The parking lot management system 100 may include a local management device installed in the parking lot 1 and a management center that controls a plurality of parking lots 1.

An automated valet parking (AVP) service may be provided in the parking lot 1. Hereinafter, a case where the automated valet parking service is provided in the parking lot 1 is described.

A vehicle 10 supporting the automated valet parking is able to automatically travel at least in the parking lot 1 without depending on a driving operation by a driver. More specifically, the vehicle 10 is provided with a recognition sensor (e.g., a camera) for recognizing a surrounding situation. The vehicle 10 automatically travels in the parking lot 1 while recognizing the surrounding situation by using the recognition sensor. Markers (landmarks) 6 for guiding the vehicle 10 may be arranged in the parking lot 1. The vehicle 10 acquires an image of the surroundings by using the camera, and recognizes the marker 6 based on the image. Based on a result of recognition of the marker 6, the vehicle 10 is able to estimate a position of vehicle 10 in the parking lot 1 with high accuracy (i.e., localization). The vehicle 10 automatically travels in the parking lot 1 based on the estimated vehicle position. The vehicle 10 may be an autonomous driving vehicle.

The parking lot management system 100 manages the automated valet parking of the vehicle 10 in the parking lot 1. The parking lot management system 100 is capable of communicating with each vehicle 10. In addition, the parking lot management system 100 is capable of communicating with a user terminal 200 of a user of the automated valet parking service. Hereinafter, an example of a flow when a certain user uses the automated valet parking service will be described.

First, the user makes a reservation of the automated valet parking. For example, the user operates the user terminal 200 to input ID information of the user, a desired parking lot 1, a desired date of use, a desired time of use (i.e., a scheduled entry time and a scheduled exit time), and the like. The user terminal 200 sends reservation information including the input information to the parking lot management system 100. The parking lot management system 100 executes reservation processing based on the reservation information/

Entry (check-in) of the vehicle 10 into the parking lot 1 is as follows.

A vehicle 10 carrying the user arrives and stops at the entry area 2 of the parking lot 1. At the entry area 2, the user gets off the vehicle 10. Then, the user requests the entry of the vehicle 10. In response to the entry request, the parking lot management system 100 conducts authentication of the user. Upon completion of the authentication, authority to operate the vehicle 10 is transferred from the user to the parking lot management system 100. The parking lot management system 100 executes an entry process with respect to the vehicle 10.

In the entry process, the parking lot management system 100 communicates with the vehicle 10 to activate the vehicle 10 (power ON).

In addition, the parking lot management system 100 refers to the usage status of each parking space 5 and allocates an available parking space 5 to the vehicle 10. Then, the parking lot management system 100 communicates with the vehicle 10 to send an entry instruction to the vehicle 10. The entry instruction includes information of the allocated parking space 5 and map information of the parking lot 1. The parking lot management system 100 may designate a target route from the entry area 2 to the allocated parking space 5.

In response to the entry instruction, the vehicle 10 initiates vehicle travel control. More specifically, the vehicle 10 automatically travels from the entry area 2 to the allocated parking space 5 and automatically parks in the allocated parking space 5. At this time, the vehicle 10 may travel along the target route designated by the parking lot management system 100. The parking lot management system 100 may communicate with the vehicle 10 to remotely control the automatic travel of the vehicle 10.

Upon completion of the parking, the vehicle 10 notifies the parking lot management system 100 of the parking completion. Alternatively, the parking lot management system 100 may use an infrastructure sensor installed in the parking lot 1 to detect completion of the parking of the vehicle 10. After the parking is completed, the parking lot management system 100 communicates with the vehicle 10 to deactivate the vehicle 10 (power OFF).

Exit (check-out) of the vehicle 10 from the parking lot 1 is as follows.

The user requests the exit of the vehicle 10 by using the user terminal 200. In response to the exit request, the parking lot management system 100 conducts authentication of the user and executes an exit process with respect to the vehicle 10.

In the exit process, the parking lot management system 100 communicates with the vehicle 10 to activate the vehicle 10 (power ON).

In addition, the parking lot management system 100 communicates with the vehicle 10 to send an exit instruction to the vehicle 10. The exit instruction includes a position of the exit area 3 and the map information of the parking lot 1. The parking lot management system 100 may designate a target route from the parking space 5 to the exit area 3.

In response to the exit instruction, the vehicle 10 initiates the vehicle travel control. More specifically, the vehicle 10 automatically travels from the parking space 5 to the exit area 3. At this time, the vehicle 10 may travel along the target route designated by the parking lot management system 100. The parking lot management system 100 may communicate with the vehicle 10 to remotely control the automatic travel of the vehicle 10.

The vehicle 10 arrives and stops at the exit area 3. The authority to operate the vehicle 10 is transferred from the parking lot management system 100 to the user. The user gets on the vehicle 10. The vehicle 10 starts moving toward a next destination.

### 2. Parking Space Monitoring Process

The parking lot management system 100 according to the present embodiment monitors each parking space 5 in the parking lot 1 by using the camera 7 installed in the parking lot 1. Hereinafter, this process is referred to as a “parking space monitoring process.” For example, the parking space monitoring process is performed for grasping the usage status (available or in use) of each parking space 5. As another example, the parking space monitoring process may be performed for checking whether the vehicle 10 has safely arrived at the allocated parking space 5. As still another example, the parking space monitoring process also is useful for monitoring vandalism to the vehicle 10 parked in the parking space 5.

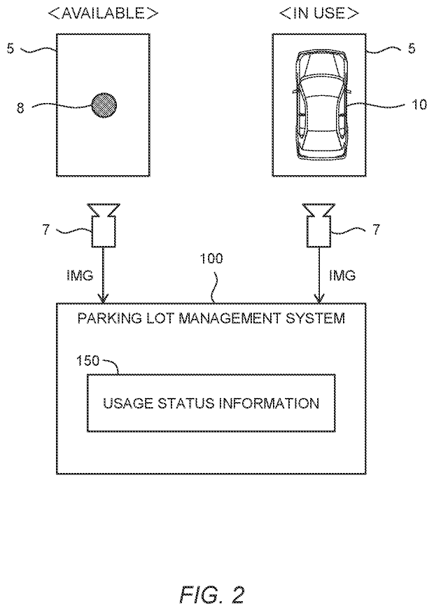

FIG. 2 is a conceptual diagram for explaining an example of a method for determining the usage status of the parking space 5. The camera 7 takes a picture of the parking space 5 and acquires an image IMG including the parking space 5. The parking lot management system 100 communicates with the camera 7 to acquire the image IMG captured by the camera 7. Then, the parking lot management system 100 determines the usage status of the parking space 5 based on the image IMG of the parking space 5.

For example, each parking space 5 is provided with a recognition target 8. The recognition target 8 is, for example, a marker drawn on a road surface. When a vehicle 10 is parked in the parking space 5, the recognition target 8 provided in the parking space 5 is hidden by the vehicle 10 and cannot be seen from the camera 7. Therefore, the parking lot management system 100 is able to determine the usage status of the parking space 5 based on whether or not the recognition target 8 is visible from the camera 7. More specifically, the parking lot management system 100 analyzes the image IMG of the parking space 5 to determine whether or not the recognition target 8 is included in the image IMG. When the recognition target 8 is included in the image IMG, the parking lot management system 100 determines that the parking space 5 is available. On the other hand, when the recognition target 8 is not included in the image IMG, the parking lot management system 100 determines that the parking space 5 is in use.

As another example, the parking lot management system 100 may hold, as a reference image, an image IMG of the parking space 5 in an available state in which no vehicle 10 is parked. In this case, parking lot management system 100 is able to determine the usage status of the parking space 5 by comparing the image IMG of the parking space 5 with the reference image.

Usage status information 150 indicates the usage status (available or in use) of each parking space 5 in the parking lot 1. The parking lot management system 100 updates the usage status information 150 through the parking space monitoring process. In addition, the parking lot management system 100 is able to grasp which parking space 5 in the parking lot 1 is currently available by referring to the usage status information 150. Typically, the usage status information 150 is used when allocating an available parking space 5 to a vehicle 10 (an entry vehicle) entering the parking lot 1.

There may be a need to monitor a plurality of parking spaces 5 with a single camera 7 in order to reduce costs.

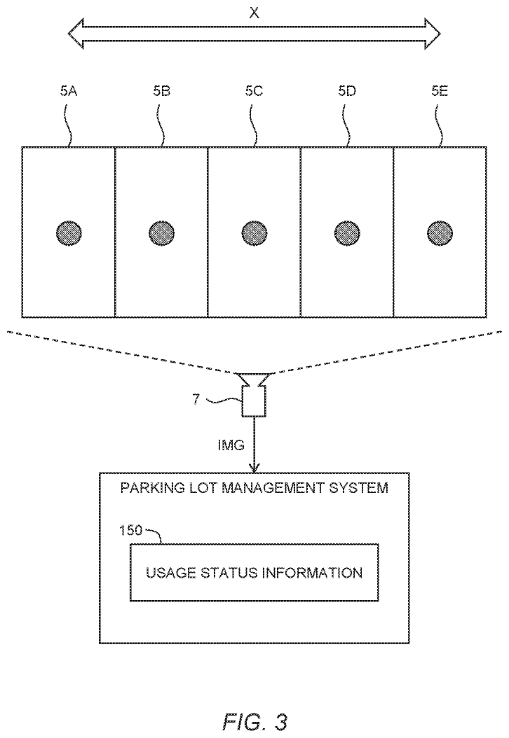

FIG. 3 shows an example of a case where a plurality of parking spaces 5 are monitored by a single camera 7. In the example shown in FIG. 3, a plurality of parking spaces 5A to 5E are arranged in series in a first direction X. Each parking space 5 may be in contact with an adjacent parking space 5. The single camera 7 is located so as to be able to take a picture of all of the plurality of parking spaces 5A to 5E. For example, the single camera 7 is located above a center parking space 5C. However, the location of the single camera 7 is not limited thereto.

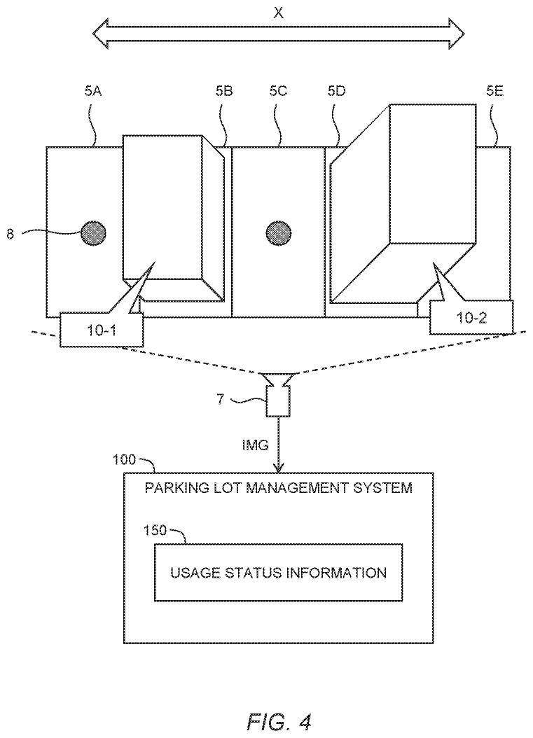

FIG. 4 is a conceptual diagram for explaining an issue. In the example shown in FIG. 4, the single camera 7 is located above the center parking space 5C. A first vehicle 10-1 that is relatively low is parked in the parking space 5B. A second vehicle 10-2 that is relatively high is parked in the parking space 5D. The other parking spaces 5A, 5C, and 5E are available.

The first vehicle 10-1 parked in the parking space 5B does not hide the recognition targets 8 provided in the adjacent parking spaces 5A and 5C. However, the second vehicle 10-2 parked in the parking space 5D hides the recognition target 8 provided in the adjacent parking space 5E. In other words, when viewed from the single camera 7, the recognition target 8 of the parking space 5E is in a blind spot formed by the second vehicle 10-2. In this case, the recognition target 8 of the parking space 5E is not included in the image IMG captured by the single camera 7. Therefore, the parking space 5E, which is actually available, may be erroneously determined to be “in use.” That is, accuracy of determination of the usage status of the parking space 5 may be reduced.

This can be generalized as follows. When a plurality of parking spaces 5 are monitored by using a single camera 7, a part of a certain parking space 5 is likely to be hidden by a vehicle 10 parked in an adjacent parking space 5. In other words, influence of occlusion on visibility of the parking space 5 increases. Depending on a size of the parked vehicle and a positional relationship between the parking space 5 and the single camera 7, the visibility of the parking space 5 may be significantly decreased. Decrease in the visibility of the parking space 5 causes decrease in accuracy of monitoring the parking space 5.

In view of the above, the present disclosure proposes a technique capable of suppressing the decrease in accuracy of monitoring when the plurality of parking spaces 5 are monitored by the single camera 7.

### 3. Parking Space Allocation Process

The parking lot management system 100 allocates an available parking space 5 to a vehicle 10 (entry vehicle) entering the parking lot 1. Hereinafter, this process is referred to as a “parking space allocation process.” According to the present embodiment, the parking space allocation process has a feature for suppressing the decrease in accuracy of monitoring.

### 3-1. Priority Parking Space

In order to describe the feature of the parking space allocation process according to the present embodiment, a concept of a “priority parking space 5P” will be described first.

It is assumed that in a state where all of the plurality of parking spaces 5 are available, a priority parking space 5P is allocated to an entry vehicle and the entry vehicle is parked in the priority parking space 5P. When viewed from the single camera 7, the entry vehicle parked in the priority parking space 5P may hide a part of an adjacent parking space 5. That is, the occlusion caused by the entry vehicle parked in the priority parking space 5P affects the visibility of the adjacent parking space 5. The priority parking space 5P is defined as a parking space 5 capable of suppressing the influence of the occlusion to less than a certain level. In other words, the priority parking space 5P is defined as a parking space 5 where a predetermined percentage or more of the adjacent parking space 5 is not hidden by the entry vehicle parked in the priority parking space 5P. Even when the entry vehicle is parked in the priority parking space 5P, a predetermined percentage or more of a parking space 5 adjacent to the priority parking space 5P is not hidden by the entry vehicle when viewed from the single camera 7. The predetermined percentage is arbitrary. For example, the predetermined percentage is 25%.

When the recognition target 8 is provided in each parking space 5, the priority parking space 5P may be defined from a viewpoint of visibility of the recognition target 8. The priority parking space 5P is defined as a parking space 5 where the recognition target 8 provided in the adjacent parking space 5 is not hidden by the entry vehicle parked in the priority parking space 5P. Even when the entry vehicle is parked in the priority parking space 5P, the recognition target 8 provided in the parking space 5 adjacent to the priority parking space 5P is not hidden by the entry vehicle when viewed from the single camera 7.

For example, in the foregoing FIG. 4, the first vehicle 10-1 parked in the parking space 5B does not hide the recognition targets 8 provided in the adjacent parking spaces 5A and 5C. Therefore, the parking space 5B is the priority parking space 5P for the first vehicle 10-1. On the other hand, the second vehicle 10-2 parked in the parking space 5D hides the recognition target 8 provided in the adjacent parking space 5E. In other words, when viewed from the single camera 7, the recognition target 8 of the parking space 5E is in a blind spot formed by the second vehicle 10-2. Therefore, the parking space 5D is not the priority parking space 5P for the second vehicle 10-2.

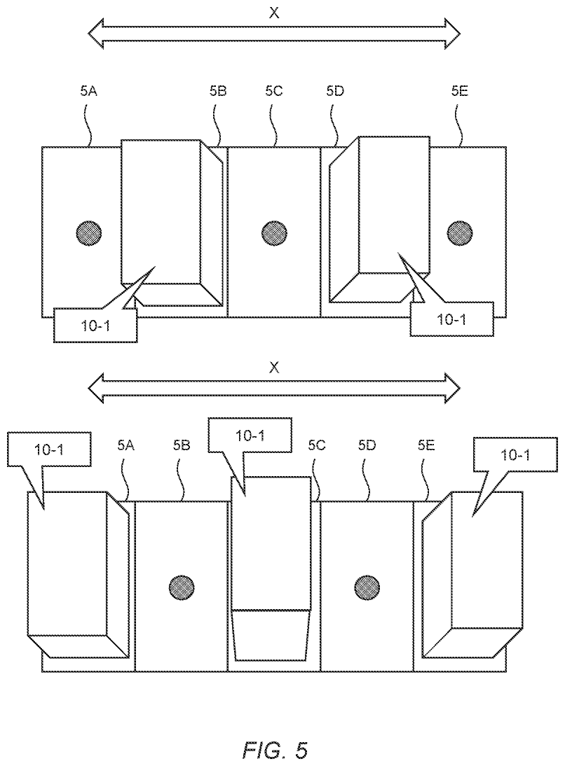

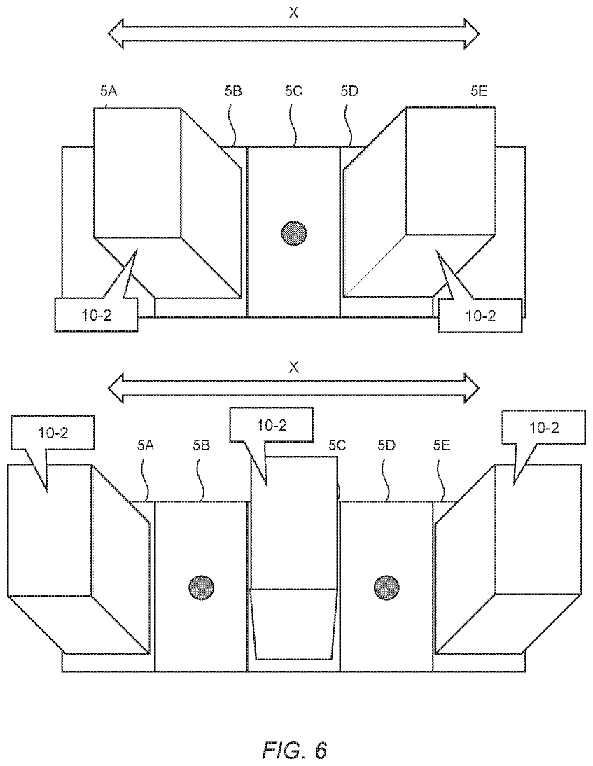

FIGS. 5 and 6 are conceptual diagrams for explaining examples of the priority parking space 5P for the first vehicle 10-1 and the second vehicle 10-2, respectively. The positional relationship between the plurality of parking spaces 5A to 5E and the single camera 7 is the same as that in the examples shown in FIGS. 3 and 4. The first vehicle 10-1 is relatively low and the second vehicle 10-2 is relatively high. More specifically, a vehicle height of the first vehicle 10-1 is lower than a threshold value TH, and a vehicle height of the second vehicle 10-2 is equal to or higher than the threshold value TH.

As to the first vehicle 10-1, as shown in FIG. 5, all of the plurality of parking spaces 5A to 5E can be the priority parking spaces 5P. For convenience sake, the priority parking space 5P for the first vehicle 10-1 is hereinafter referred to as a “first parking space 5P-1.” In the example shown in FIG. 5, all of the plurality of parking spaces 5A to 5E are the first parking spaces 5P-1.

On the other hand, as to the second vehicle 10-2, as shown in FIG. 6, the parking spaces 5A, 5C, and 5E are the priority parking spaces 5P, but the parking spaces 5B and 5D are not the priority parking spaces 5P. For convenience sake, the priority parking space 5P for the second vehicle 10-2 is hereinafter referred to as a “second parking space 5P-2.” In the example shown in FIG. 6, three parking spaces 5A, 5C, and 5E are the second parking spaces 5P-2.

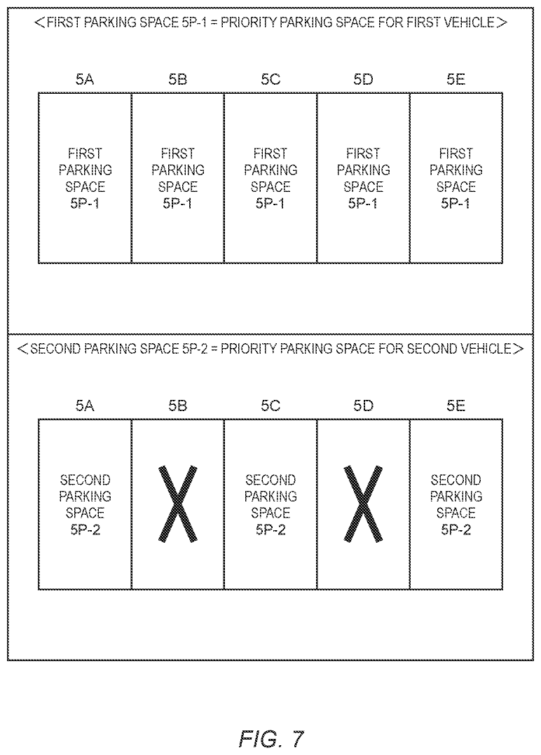

FIG. 7 is a conceptual diagram showing an example of the first parking spaces 5P-1 and the second parking spaces 5P-2. As shown in FIG. 7, the number of the first parking spaces 5P-1 is larger than the number of the second parking spaces 5P-2, and the second parking spaces 5P-2 are a part of the first parking spaces 5P-1. In other words, a set of the first parking spaces 5P-1 includes a set of the second parking spaces 5P-2. This relationship does not change even when the number of types of vehicle 10 is three or more. As the vehicle height of the entry vehicle increases, the number of candidates that can be the priority parking space 5P decreases.

As described with reference to FIGS. 5 to 7, the priority parking space 5P greatly depends on the vehicle height. In addition, not only the vehicle height but also a vehicle width and a vehicle length are considered to contribute to the occlusion. To generalize, the priority parking space 5P included in the plurality of parking spaces 5 monitored by the single camera 7 depends on a “size” of the entry vehicle. As the size of the entry vehicle increases, the number of candidates that can be the priority parking space 5P decreases.

### 3-2. Allocation of Priority Parking Space

As described above, when the entry vehicle is parked in the priority parking space 5P, the influence of the occlusion caused by the entry vehicle is suppressed to less than a certain level. In some embodiments, in order to suppress the influence of the occlusion, the priority parking space 5P is allocated to the entry vehicle as much as possible. Therefore, according to the present embodiment, the parking lot management system 100 preferentially allocates the priority parking space 5P to the entry vehicle in the parking space allocation process.

More specifically, the parking lot management system 100 acquires information on a size of the entry vehicle. For example, a sensor (e.g., a camera, an infrared sensor, or the like) is installed in the entry area 2 of the parking lot 1, and the size of the entry vehicle is measured by the sensor. The parking lot management system 100 communicates with the sensor to acquire the information on the size of the entry vehicle.

As another example, the user may input a vehicle type of the entry vehicle by using the user terminal 200. The parking lot management system 100 communicates with the user terminal 200 to acquire the information on the vehicle type of the entry vehicle. The parking lot management system 100 holds a database indicating a correspondence relationship between vehicle types and sizes, and acquires information on the size associated with the vehicle type of the entry vehicle. The user may input the size itself of the entry vehicle by using the user terminal 200. In the case of the automated valet parking service, the user may input the vehicle type or the size at the time of making a reservation.

Subsequently, the parking lot management system 100 recognizes the priority parking space 5P among the plurality of parking spaces 5 based on the size of the entry vehicle. In other words, the parking lot management system 100 recognizes the priority parking space 5P according to the size of the entry vehicle from among the plurality of parking spaces 5 monitored by the single camera 7. The positional relationship between the single camera 7 and the plurality of parking spaces 5 is known information. The priority parking space 5P is determined by the known information and the size of the entry vehicle.

Then, the parking lot management system 100 preferentially allocates the priority parking space 5P to the entry vehicle. For example, when the entry vehicle is the first vehicle 10-1, the parking lot management system 100 preferentially allocates the first parking space 5P-1 to the entry vehicle (the first vehicle 10-1) (see FIGS. 5 and 7). As another example, when the entry vehicle is the second vehicle 10-2, the parking lot management system 100 preferentially allocates the second parking space 5P-2 to the entry vehicle (the second vehicle 10-2) (see FIGS. 6 and 7).

It should be noted that “preferentially allocating the priority parking space 5P to the entry vehicle” does not mean “always allocating the priority parking space 5P to the entry vehicle.” When all of the priority parking spaces 5P are already in use, that is, when there is no available priority parking space 5P, the parking lot management system 100 may allocate the parking space 5 other than the priority parking space 5P to the entry vehicle.

### 3-3. Effects

As described above, according to the present embodiment, the priority parking space 5P is preferentially allocated to the entry vehicle in the parking space allocation process. When the entry vehicle is parked in the priority parking space 5P, the influence of occlusion caused by the entry vehicle is suppressed to less than a certain level. It is thus possible to suppress the decrease in accuracy of monitoring even in the situation where the plurality of parking spaces 5 are monitored by the single camera 7.

For example, a probability that a vehicle 10 parked in a certain parking space 5 hides the recognition target 8 of the adjacent parking space 5 is reduced. Therefore, a possibility that an actually available parking space 5 is erroneously determined to be “in use” is reduced. This contributes to improvement in accuracy and reliability of the parking space allocation process.

### 3-4. Preservation of Priority Parking Space

As described above, the first parking space 5P-1 is the priority parking space 5P for the first vehicle 10-1. The second parking space 5P-2 is the priority parking space 5P for the second vehicle 10-2. As shown in FIG. 7, the number of the first parking spaces 5P-1 is larger than the number of the second parking spaces 5P-2, and the second parking spaces 5P-2 are a part of the first parking spaces 5P-1. In other words, a set of the first parking spaces 5P-1 includes a set of the second parking spaces 5P-2.

Here, a case where the entry vehicle is the first vehicle 10-1 is considered. For example, the parking space 5C serves as not only the first parking space 5P-1 but also the second parking space 5P-2. If the parking space 5C is allocated to the entry vehicle (the first vehicle 10-1), the number of available second parking spaces 5P-2, which is originally small, is further reduced. If no available second parking space 5P-2 remains when the second vehicle 10-2 enters the parking lot next, it is not possible to allocate the second parking space 5P-2 to the second vehicle 10-2. Meanwhile, the parking space 5B is the first parking space 5P-1 but is not the second parking space 5P-2. Even when the parking space 5B is allocated to the entry vehicle (the first vehicle 10-1), the number of available second parking spaces 5P-2 is not reduced.

In some embodiments, in view of the above, when the entry vehicle is the first vehicle 10-1, the parking lot management system 100 preferentially allocates the first parking space 5P-1 that is not the second parking space 5P-2 to the entry vehicle. Thus, the second parking space 5P-2 is preserved. As a result, when the second vehicle 10-2 enters the parking lot next, a probability that the second parking space 5P-2 is allocated to the second vehicle 10-2 is increased. That is, the parking space allocation process according to the present embodiment is promoted, and thus the effect is further increased.

### 3-5. Priorities of Parking Spaces

Finer priorities may be set for the plurality of parking spaces 5. In this case, the parking lot management system 100 performs the parking space allocation process in consideration of the priorities. That is, the parking lot management system 100 allocates the parking space 5 to the entry vehicle according to the priorities.

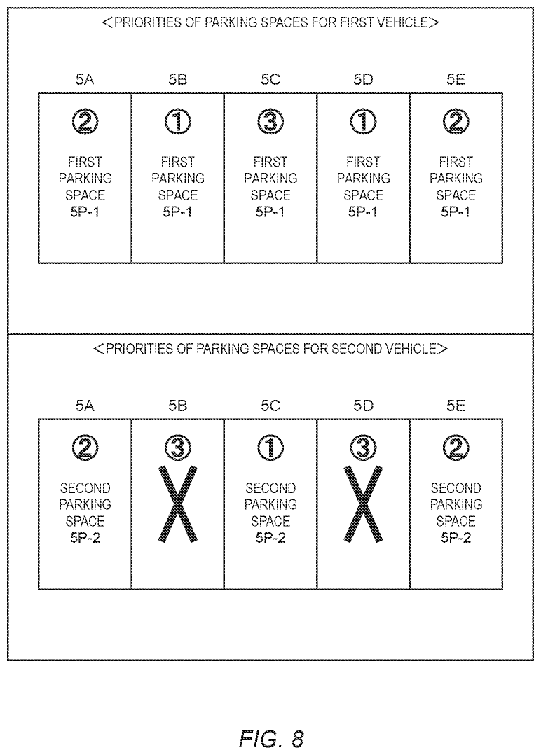

FIG. 8 is a conceptual diagram showing an example of setting of the priorities of the parking spaces 5. The first parking spaces 5P-1 and the second parking spaces 5P-2 are the same as those in the example shown in FIG. 7.

An “edge parking space” is a parking space 5 located at an endmost of the plurality of parking spaces 5 monitored by the single camera 7. In other words, the edge parking space is the parking space 5 located at the end in the first direction X. In the example shown in FIG. 8, each of the parking spaces 5A and 5E is the edge parking space. The edge parking space (5A, 5E) serves as both the first parking space 5P-1 and the second parking space 5P-2.

An “intermediate parking space” is a parking space 5 other than the edge parking space among the plurality of parking spaces 5 monitored by the single camera 7. In the example shown in FIG. 8, each of the parking spaces 5B, 5C, and 5D is the intermediate parking space.

First, the priorities in a case where the entry vehicle is the second vehicle 10-2 is considered. Even when the second vehicle 10-2 is parked in the edge parking space (5A, 5E), the other parking spaces 5B to 5D are not hidden by the second vehicle 10-2. However, when the second vehicle 10-2 is parked in the edge parking space (5A, 5E), the passage 4 adjacent to the edge parking space (5A, 5E) is hidden by the second vehicle 10-2. There may be a need to monitor the passage 4 of the parking lot 1 by using the camera 7.

In view of the above, when the entry vehicle is the second vehicle 10-2, the parking lot management system 100 sets the priority of the intermediate parking space (5C) being the second parking space 5P-2 to be higher than the priority of the edge parking space (5A, 5E). Moreover, the parking lot management system 100 sets the priorities of the parking spaces 5B and 5D other than the second parking space 5P-2 to the lowest. Therefore, in the case where the entry vehicle is the second vehicle 10-2, the priorities are as follows: the intermediate parking space (5C) being the second parking space 5P-2>the edge parking space (5A, 5E)>the parking space (5B, 5D) other than the second parking space 5P-2.

Next, the priorities in a case where the entry vehicle is the first vehicle 10-1 is considered. In some embodiments, from the viewpoint of the preservation of the second parking space 5P-2 described above, the first parking space 5P-1 (5B, 5D) which is not the second parking space 5P-2 is preferentially allocated to the entry vehicle. Therefore, the parking lot management system 100 sets the priority of the first parking space 5P-1 (5B, 5D) that is not the second parking space 5P-2 to be the highest. In some embodiments, the intermediate parking space (5C) having the highest priority is preserved for second vehicle 10-2 as much as possible. Therefore, the parking lot management system 100 sets the priority of the intermediate parking space (5C) that is the second parking space 5C-2 to be lowest. Therefore, in the case where the entry vehicle is the first vehicle 10-1, the priorities are as follows: the first parking space 5P-1 (5B, 5D) that is not the second parking space 5P-2>the edge parking space (5A, 5E)>the intermediate parking space (5C) being the second parking space 5P-2.”

As can be seen from FIG. 8, the priorities in the case of the first vehicle 10-1 are opposite to the priorities in the case of the second vehicle 10-2.

Considering the priorities as well makes it possible to achieve a more detailed parking space allocation process. As a result, the effect of the parking space allocation process increases.

### 4. Example of Parking Lot Management System

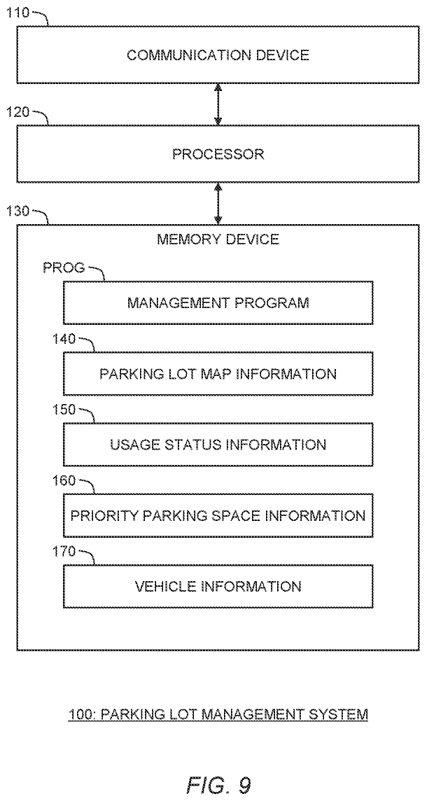

FIG. 9 is a block diagram showing a configuration example of the parking lot management system 100 according to the present embodiment. The parking lot management system 100 includes a communication device 110, one or more processors 120 (hereinafter simply referred to as a processor 120), and one or more memory devices 130 (hereinafter simply referred to as a memory device 130).

The communication device 110 communicates with the camera 7 installed in the parking lot 1. In addition, the communication device 110 communicates with the vehicle 10 and the user terminal 200 (see FIG. 1).

The processor 120 executes a variety of processing. For example, the processor 120 includes a central processing unit (CPU). The processor 120 executes a variety of processing related to the management of the parking lot 1. For example, the processor 120 communicates with the camera 7, the vehicle 10, the user terminal 200, and the like via the communication device 110. Moreover, the processor 120 executes the parking space monitoring process described above (see Section 2). Furthermore, the processor 120 executes the parking space allocation process described above (see Section 3).

The memory device 130 stores a variety of information necessary for the processing by the processor 120. Examples of the memory device 130 include a volatile memory, a nonvolatile memory, a hard disk drive (HDD), a solid state drive (SSD), and the like. The processor 120 reads out a variety of information from the memory device 130 and stores a variety of information in the memory device 130.

A management program PROG is a computer program for managing the parking lot 1. A variety of functions of the parking lot management system 100 (the processor 120) may be implemented by the processor 120 executing the management program PROG. The management program PROG is stored in the memory device 130. The management program PROG may be recorded on a non-transitory computer-readable recording medium.

The memory device 130 also stores parking lot map information 140, usage status information 150, priority parking space information 160, vehicle information 170, and the like.

The parking lot map information 140 is map information of the parking lot 1. The parking lot map information 140 indicates an arrangement of the entry area 2, the exit area 3, the passage 4, the parking spaces 5, the markers 6, the camera 7, the recognition targets 8, and the like in the parking lot 1. A positional relationship between the single camera 7 and the plurality of parking spaces 5 can be obtained from the parking lot map information 140.

The usage status information 150 indicates the usage status (available or in use) of each parking space 5 in the parking lot 1. The processor 120 updates the usage status information 150 through the parking space monitoring process. In addition, the processor 120 is able to grasp which parking space 5 in the parking lot 1 is currently available by referring to the usage status information 150. Typically, the usage status information 150 is used in the parking space allocation process.

The priority parking space information 160 indicates the priority parking space 5P included in the plurality of parking spaces 5 monitored by the single camera 7. As described above, the priority parking space 5P is determined by the size of the entry vehicle and the positional relationship between the single camera 7 and the plurality of parking spaces 5. The positional relationship between the single camera 7 and the plurality of parking spaces 5, which is known information, is acquired from the parking lot map information 140. The processor 120 generates in advance the priority parking space information 160 indicating the correspondence relationship between the size of the entry vehicle and the priority parking space 5P.

The vehicle information 170 is information on the vehicle 10 parked or to be parked in the parking lot 1. The vehicle 10 to be parked in the parking lot 1 includes the entry vehicle entering the parking lot 1. For example, the vehicle information 170 indicates a vehicle ID and a size for each vehicle 10. The vehicle information 170 may indicate the parking space 5 allocated to each vehicle 10.

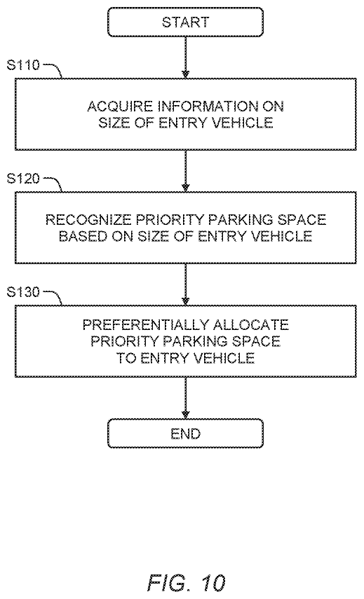

FIG. 10 is a flowchart showing the parking space allocation process performed by the parking lot management system 100 (the processor 120).

In Step S110, the processor 120 acquires information on the size of the entry vehicle. The processor 120 registers the information on the size of the entry vehicle in the vehicle information 170.

For example, a sensor (e.g., a camera, an infrared sensor, or the like) is installed in the entry area 2 of the parking lot 1, and the size of the entry vehicle is measured by the sensor. The processor 120 communicates with the sensor to acquire the information on the size of the entry vehicle.

As another example, the user may input a vehicle type of the entry vehicle by using the user terminal 200. The processor 120 communicates with the user terminal 200 to acquire the information on the vehicle type of the entry vehicle. By referring to a database indicating a correspondence relationship between vehicle types and sizes, the processor 120 acquires information on the size associated with the vehicle type of the entry vehicle. The user may input the size itself of the entry vehicle by using the user terminal 200. In the case of the automated valet parking service, the user may input the vehicle type or the size at the time of making a reservation.

In Step S120, the processor 120 recognizes the priority parking space 5P among the plurality of parking spaces 5 based on the size of the entry vehicle. In other words, the processor 120 recognizes the priority parking space 5P according to the size of the entry vehicle from among the plurality of parking spaces 5 monitored by the single camera 7. More specifically, the processor 120 recognizes the priority parking space 5P according to the size of the entry vehicle by referring to the priority parking space information 160 described above.

In Step S130, the processor 120 preferentially allocates the priority parking space 5P to the entry vehicle. For example, when the entry vehicle is the first vehicle 10-1, the processor 120 preferentially allocates the first parking space 5P-1 to the entry vehicle (the first vehicle 10-1) (see FIGS. 5 and 7). As another example, when the entry vehicle is the second vehicle 10-2, the processor 120 preferentially allocates the second parking space 5P-2 to the entry vehicle (the second vehicle 10-2) (see FIGS. 6 and 7). Then, the processor 120 updates the usage status information 150.

What is claimed is:

1. A parking lot management method for managing a parking lot including a plurality of parking spaces monitored by a single camera,
the parking lot management method comprising a parking space allocation process that allocates an available parking space among the plurality of parking spaces to an entry vehicle entering the parking lot, wherein
the plurality of parking spaces include a priority parking space depending on a size of the entry vehicle,
even when the entry vehicle is parked in the priority parking space, a predetermined percentage or more of a parking space adjacent to the priority parking space is not hidden by the entry vehicle when viewed from the single camera, and
the parking space allocation process includes:
acquiring information on the size of the entry vehicle;
recognizing the priority parking space among the plurality of parking spaces based on the size of the entry vehicle; and
preferentially allocating the priority parking space to the entry vehicle.

2. The parking lot management method according to claim 1, wherein
a first parking space is the priority parking space for a first vehicle whose vehicle height is lower than a threshold value,
a second parking space is the priority parking space for a second vehicle whose vehicle height is equal to or higher than the threshold value,
a set of first parking spaces includes a set of second parking spaces,
when the entry vehicle is the first vehicle, the parking space allocation process includes preferentially allocating the first parking space to the entry vehicle, and
when the entry vehicle is the second vehicle, the parking space allocation process includes preferentially allocating the second parking space to the entry vehicle.

3. The parking lot management method according to claim 2, wherein
when the entry vehicle is the first vehicle, the parking space allocation process includes preferentially allocating the first parking space that is not the second parking space to the entry vehicle.

4. The parking lot management method according to claim 2, wherein
the plurality of parking spaces are arranged in series in a first direction,
an edge parking space is a parking space located at an endmost of the plurality of parking spaces, and
the edge parking space serves as both the first parking space and the second parking space.

5. The parking lot management method according to claim 4, wherein
an intermediate parking space is a parking space other than the edge parking space among the plurality of parking spaces, and
when the entry vehicle is the second vehicle, a priority of the intermediate parking space being the second parking space is higher than a priority of the edge parking space.

6. The parking lot management method according to claim 4, wherein
an intermediate parking space is a parking space other than the edge parking space among the plurality of parking spaces, and
when the entry vehicle is the first vehicle, the first parking space that is not the second parking space has a highest priority, and the intermediate parking space that is the second parking space has a lowest priority.

7. The parking lot management method according to claim 1, wherein
each of the plurality of parking spaces is provided with a recognition target,
a usage status of each of the plurality of parking spaces is determined based on whether or not the recognition target is visible from the single camera, and
even when the entry vehicle is parked in the priority parking space, the recognition target provided in the parking space adjacent to the priority parking space is not hidden by the entry vehicle when viewed from the single camera.

8. The parking lot management method according to claim 1, wherein
the plurality of parking spaces are arranged in series in a first direction.

9. A parking lot management system for managing a parking lot including a plurality of parking spaces monitored by a single camera,
the parking lot management system comprising one or more processors configured to execute a parking space allocation process that allocates an available parking space among the plurality of parking spaces to an entry vehicle entering the parking lot, wherein
the plurality of parking spaces include a priority parking space depending on a size of the entry vehicle,
even when the entry vehicle is parked in the priority parking space, a predetermined percentage or more of a parking space adjacent to the priority parking space is not hidden by the entry vehicle when viewed from the single camera, and
the parking space allocation process includes:
acquiring information on the size of the entry vehicle;
recognizing the priority parking space among the plurality of parking spaces based on the size of the entry vehicle; and
preferentially allocating the priority parking space to the entry vehicle.
